(19) United States
(12) Patent Application Publication
(10) Pub. No.: US 2025/0315144 A1
(43) Pub. Date: Oct. 9, 2025

(54) SYSTEM AND METHOD FOR MANAGING EVENTS USING AN AVATAR BASED USER INTERFACE

(71) Applicant: Jade C. Johnson, Brooklyn, NY (US)

(72) Inventor: Jade C. Johnson, Brooklyn, NY (US)

(21) Appl. No.: 18/625,820

(22) Filed: Apr. 3, 2024

(51) Int. Cl. G06F 3/04815; G06F 3/0484; G06Q 10/1093; G06T 19/00

(52) U.S. Cl. CPC G06F 3/04815; G06F 3/0484; G06Q 10/1093; G06T 19/00; G06T 2200/24; G06T 2219/024

(57) ABSTRACT

The following disclosure relates to a system and method for managing events using an avatar based user interface. The system includes: a graphical user interface (GUI) for a user to visually interact with an avatar; and at least one processor. The at least one processor is configured to: receive, via the GUI, event information pertaining to a body part of the user; associate the event information to a body part of the avatar, wherein the body part of the avatar corresponds to the body part of the user; and generate a reminder for the user based on the event information associated to the body part of the avatar.

### FIELD

The following disclosure relates to a system and method for managing events using an avatar based user interface.

### BACKGROUND

Effective task management and reminders play a vital role in maintaining productivity and reducing stress. Many individuals struggle with staying organized and efficiently managing their tasks, often encountering issues such as forgetting important deadlines, neglecting appointments, and feeling overwhelmed due to a lack of structure. One common challenge is relying solely on memory to recall tasks, leading to forgetfulness and missed opportunities. Lacking a centralized system for tracking tasks can result in scattered information and overlooked items. Additionally, various appointments and events are often scheduled in different intervals (e.g., every three weeks vs. bi-weekly) which can cause subsequent days or weeks to look different and require different planning.

Another common challenge is keeping task management fun and interesting. Traditional task management systems, such as calendars, lack the efficiency and enjoyment brought by visual effects. Without these captivating visual cues, the interface can become uninteresting and less engaging, potentially resulting in reduced user interaction. This absence of visual distinction can lead to information overload, making it difficult for users to differentiate between various events and tasks on their calendars, especially when they are scheduled at different intervals. Moreover, the lack of visual effects complicates the process of prioritizing tasks and events, potentially causing users to miss deadlines or forget appointments. The intuitiveness of traditional task management applications suffers as users may struggle to navigate and comprehend the interface without visual cues, particularly affecting users with diverse learning styles and accessibility requirements. Furthermore, without visual effects, the emotional connection between users and the traditional application weakens, as visual effects often evoke emotions and create a more personalized experience.

### SUMMARY

In one embodiment a system for managing events using an avatar-based user interface is provided. The system includes a graphical user interface (GUI) for a user to visually interact with an avatar, and at least one processor. The at least one processor may be configured to: receive, via the GUI, event information pertaining to a body part of the user; and associate the event information to a body part of the avatar. The body part of the avatar may correspond to the body part of the user. The at least one processor may be also configured to generate a reminder for the user based on the event information associated to the body part of the avatar.

In another embodiment, the avatar may be configured to be personalized. The avatar may be a two-dimensional or three-dimensional figure.

In another embodiment, the body part of the avatar may include subparts.

In another embodiment, the event information may be indicative of appointment information with respect to a service provider, indicative of tasks, indicative of goals, or a combination thereof.

In another embodiment, the at least one processor may be further configured to display, via the GUI, the reminder. The reminder may include a date, a time, and a location associated with the event information.

In another embodiment, the at least one processor may be further configured to prompt, via the GUI, the user to acknowledge the reminder.

In another embodiment, the at least one processor may be further configured to assign a priority level to the reminder based on a deadline of the reminder, a level of importance of the reminder, or a combination thereof. The at least one processor may also be configured to modify an appearance of the body part of the avatar associated with the reminder based on the priority level.

In another embodiment, a heat map may be generated on the avatar based on the priority level.

In another embodiment, the at least one processor may be further configured to display, via the GUI, at least one message when the body part of the avatar is selected. The message and the selected body part of the avatar may be displayed simultaneously, and the message may include a date, a time, a location, a description, a priority level, or a combination thereof associated with the event information.

In another embodiment, the at least one processor may be further configured to store a user profile associated with the user in a database. The user profile may include the avatar having the generated reminder associated to the body part of the avatar. The at least one processor may be further configured to transmit the user profile to at least one other user, such as to enable collaborative interaction between the users.

In another embodiment, a computer-implemented method for managing events using an avatar-based user interface is provided. The computer-implemented method may include: receiving, by a processor through a graphical user interface (GUI), event information pertaining to a body part of the user; and associating, by the processor, the event information to a body part of an avatar. The body part of the avatar may correspond to the body part of the user. The computer-implemented method may also include generating, by the processor, a reminder for the user based on the event information associated to the body part of the avatar.

In another embodiment, the computer-implemented method may further include assigning, by the processor, a priority level to the generated reminder based on a deadline of the reminder, a level of importance of the reminder, or a combination thereof. The computer-implemented method may also include modifying, by the processor, an appearance of the body part of the avatar associated with the reminder based on the priority level.

In another embodiment, the computer-implemented method may further include displaying, via the GUI, the reminder. The reminder may include a date, a time, and a location associated with the event information.

In another embodiment, the computer-implemented method may further include prompting, by the processor, the user to acknowledge the reminder.

In another embodiment, the computer-implemented method may further include displaying, via the GUI, at least one message when the body part of the avatar is selected. The message and the selected body part of the avatar may be displayed simultaneously. The message may include a date, a time, a location, a description, a priority level, or a combination thereof associated with the event information.

In another embodiment, the avatar may be configured to be visually interacted with via the GUI.

In another embodiment, the avatar may be configured to be personalized. The avatar may also be a two-dimensional or three-dimensional figure.

In another embodiment, the body part of the avatar may include subparts.

In another embodiment, the event information may be indicative of appointment information with respect to a service provider, indicative of tasks, indicative of goals, or a combination thereof.

In another embodiment, the computer-implemented may further include storing, by the processor, a user profile associated with the user in a database. The user profile may include the avatar having the generated reminder associated to the body part of the avatar. The computer-implemented method may also include transmitting, by the processor, the user profile to at least one other user, such as to enable collaborative interaction between the users.

In another embodiment, another system for managing events using an avatar-based user interface is provided. The system may include: a means for receiving event information pertaining to a body part of the user; and a means for associating the event information to a body part of the avatar. The body part of the avatar may correspond to the body part of the user. The system also includes a means for generating a reminder for the user based on the event information associated to the body part of the avatar.

In another embodiment, the system may further include a means for assigning a priority level to the reminder based on a deadline of the reminder, a level of importance of the reminder, or a combination thereof. The system may also include a means for modifying an appearance of the body part of the avatar associated with the reminder based on the priority level.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Embodiments are described herein with reference to the following drawings.

FIG. 1 depicts a network environment for managing events using an avatar based user interface, according to one embodiment.

FIG. 2 depicts an illustrative embodiment of a specialized computer system configured for managing events using an avatar based user interface.

FIG. 3 depicts a flowchart describing a computer-implemented method for managing events using an avatar-based user interface, according to one embodiment.

FIG. 4 depicts an illustration of a screenshot of a profile screen from a mobile device in accordance with an embodiment of a system for managing events using an avatar based user interface.

FIG. 5 depicts an illustration of a screenshot of an avatar configuration screen from a mobile device in accordance with an embodiment of a system for managing events using an avatar based user interface.

FIG. 6 depicts an illustration of a screenshot of a main menu from a mobile device in accordance with an embodiment of a system for managing events using an avatar based user interface.

FIG. 7 depicts an illustration of a screenshot of an avatar where a popup or insert image of a selected body part is displayed from a mobile device in accordance with an embodiment of a system for managing events using an avatar based user interface.

FIG. 8 depicts an illustration of a screenshot of an input screen that allows a user to enter event information from a mobile device in accordance with an embodiment of a system for managing events using an avatar based user interface.

FIG. 9 depicts an illustration of a screenshot of a reminder of a mobile device in accordance with an embodiment of a system for managing events using an avatar based user interface.

FIG. 10 depicts an illustration of a screenshot of a message of a mobile device in accordance with an embodiment of a system for managing events using an avatar based user interface.

FIG. 11 depicts an illustration of a screenshot of a reminder of a mobile device in accordance with an embodiment of a system for managing events using an avatar based user interface.

FIG. 12 depicts an illustration of a screenshot, which includes an avatar having body parts assigned to different priority levels, of a mobile device in accordance with an embodiment of a system for managing events using an avatar based user interface.

While the disclosed methods and systems are representative of embodiments in various forms, specific embodiments are illustrated in the drawings (and are hereafter described), with the understanding that the disclosure is intended to be illustrative and is not intended to limit the claim scope to the specific embodiments described and illustrated herein.

### DETAILED DESCRIPTION

An object of the present disclosure is to help a user stay organized by taking away the tedious work component of setting up tasks, appointments, and tracking timelines (as well as anticipate upcoming appointments) in traditional task management applications, and instead, make managing events more fun and engaging.

Another object of the present disclosure is to assist users in tracking appointments and tasks related to their body, while eliminating any negative connotations or need for secrecy. The goal is to promote the idea that seeking appointments for enhancing one's appearance and well-being is a normal and positive aspect of maintaining happiness and health.

Therefore, the disclosed embodiments relate to a system and method for managing events using an avatar based user interface. The disclosed system manages events relating to a user's body using a graphical user interface (GUI). For instance, an avatar is used as a visual representation of the user's body. The avatar may be configured to any shape of the user's body to help the user be comfortable with his/her/their appearance without any outside influence. The user's event information (e.g., event data) is associated with a body part of the avatar. A reminder is created for the user based on the event information associated with the body part of the avatar.

Numerous specific details are set forth to provide a thorough understanding of the overall structure, function, manufacture, and use of the embodiments as described in the specification and illustrated in the accompanying drawings. Well-known operations, components, and elements have not been described in detail so as not to obscure the embodiments described in the specification. The reader will understand that the embodiments described and illustrated herein are non-limiting examples, and thus it can be appreciated that the specific structural and functional details disclosed herein may be representative and illustrative. Variations and changes thereto may be made without departing from the scope of the claims.

Spatial and functional relationships between elements (for example, between modules) are described using various terms, including “connected,” “engaged,” “interfaced,” and “coupled.” Unless explicitly described as being “direct,” when a relationship between first and second elements is described in the disclosure herein, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

When a component, device, element, or the like of the present disclosure is described as having a purpose or performing an operation, function, or the like, the component, device, or element should be considered herein as being “configured to” meet that purpose or to perform that operation or function.

The terminology used herein is for the purpose of describing particular embodiments only and is not intended to be limiting of example embodiments of the present disclosure. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “exemplary” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Before discussing example embodiments in more detail, it is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments of the present disclosure. This disclosure may, however, be embodied in many alternate forms and should not be construed as limited to only the embodiments set forth herein.

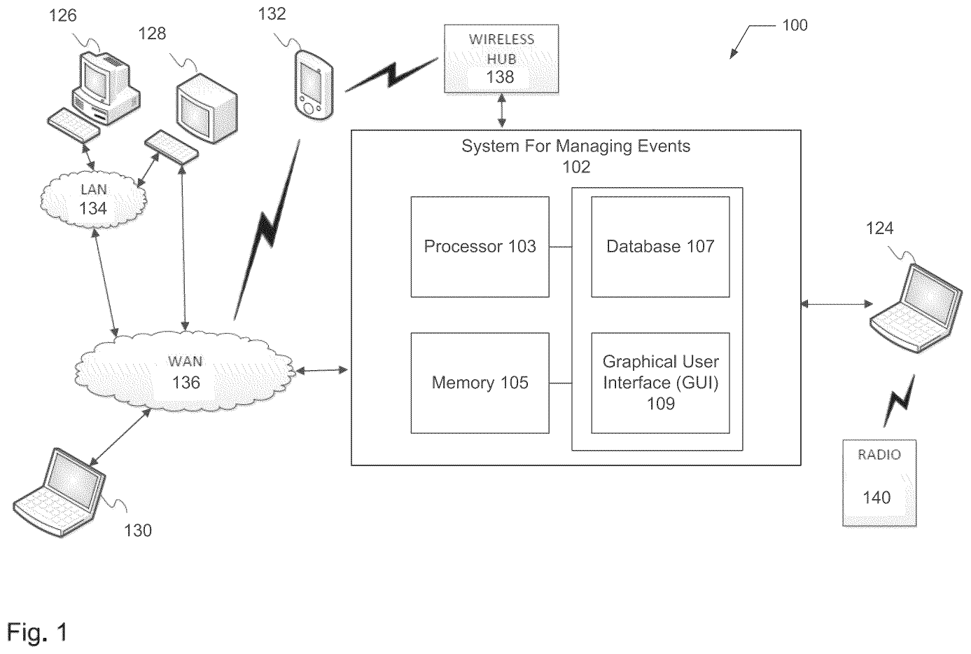

Referencing FIG. 1, a network environment 100 for managing events using an avatar based user interface, is depicted. A system for managing events 102 (i.e., the system) is further illustrated in FIG. 1 and may receive, transmit, and/or store electronic data including documents, event information, reminders, and profiles in a database 107 between users, such as via wide area network (WAN) 136 and/or local area network (LAN) 134 and computer devices 124, 126, 128, 130 and 132, as will be described below, coupled with the system 102.

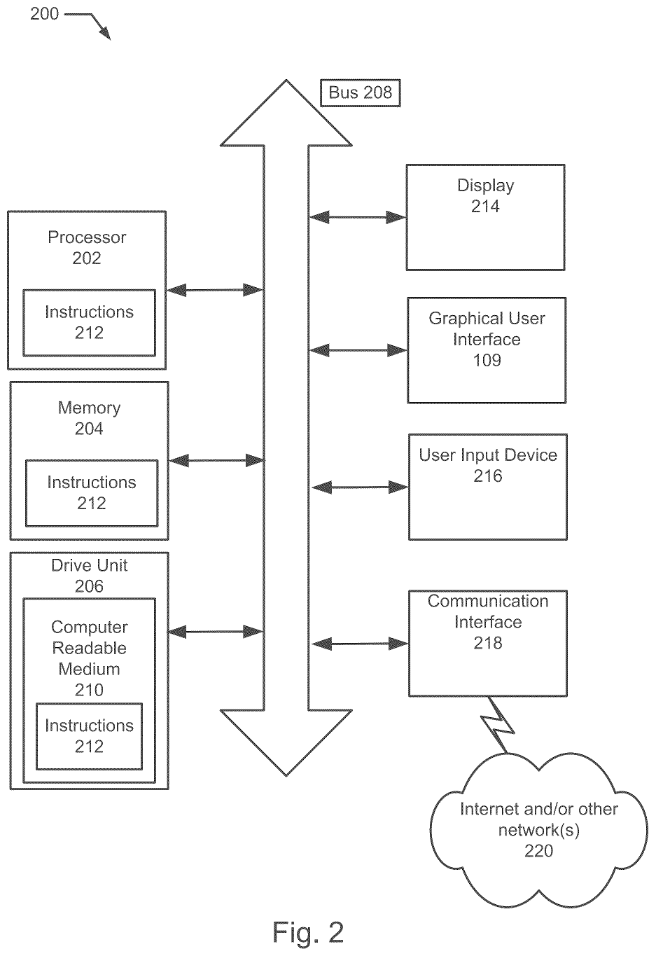

The system 102 shown in FIG. 1 may be implemented as a separate component or as one or more logic components, such as on a field programmable gate array (FPGA) that may include a memory 105 or reconfigurable component to store logic and a processing component to execute the stored logic, or as computer program logic, stored in the memory 105, or other non-transitory computer readable medium, and executable by a processor 103, such as the processor 202 and memory 204 described below with respect to FIG. 2. In one embodiment, the system 102 is implemented by a server computer, e.g., a web server, coupled with one or more client devices 124, 126, 128, 130, and 132, such as computers, mobile devices, etc. via a wired and/or wireless electronic communications network, such as the WAN 136, LAN 134, and/or radio 140, in a network environment 100. In one embodiment, client devices 124, 126, 128, 130, 132 interact with the system 102 of the server computer to provide inputs thereto and receive outputs therefrom as described herein. The system 102 may also be implemented with one or more mainframe, desktop or other computers, such as the computer 200 described below with respect to FIG. 2.

In another embodiment, the system 102 may be incorporated as one system with different modules within the system. In another embodiment, the system 102 may be separate and distinct with multiple separate modules. It will be appreciated that the disclosed embodiments may be applicable to other types of electronic documents and messages, and systems, beyond those described specifically with respect to the system 102. Further, the database 107, or other datasets, and/or the data contained therein, may be communicated throughout the system 102 using one or more data packets, datagrams or other collection of data formatted, arranged, configured and/or packaged in a particular one or more protocols, e.g. FTP, UDP, TCP/IP, Ethernet, etc., suitable for transmission via networks 134 and 136 as was described, such as the dataset communication format and/or protocols.

The system 102 includes a processor 103 and a non-transitory memory 105 coupled therewith which may be implemented as a processor 202 and memory 204 as described below with respect to FIG. 2. As shown, the system 102 includes various logical functions, individual devices, and/or combined devices. The logical functions, individual devices, and/or combined devices may share the processor 103 as shown, or may include individual processors, as well as any combination or shared processing abilities over multiple processors. As such, multiple processors 103 may be used in dedicated applications for the particular individual devices, and/or combined devices, or in any shared combination.

The processor 103 may be configured to perform the operation of managing events using an avatar-based user interface, as further described below.

The system 102 also includes a graphical user interface (GUI) 109. The GUI 109 instructions are stored in the memory 105 and executable by the processor 103. The GUI 109 may be used for one or more purposes, including to convey and/or receive information about the users, displaying (e.g., outputting) an avatar, displaying a reminder, promoting a reminder, displaying at least one message, and the like.

For example, the system 102 may provide a user, through the GUI 109, a set of questions or prompts that guide the user through a personalization process. In other words, the user may personalize and/or reconfigure the avatar to appear as the users wishes, via the GUI 109. The GUI 109 may then display the personalized avatar.

The GUI 109 may also display the configured avatar and highlight certain body parts of the avatar based on priority level (described further below).

Furthermore, the GUI 109 may display multiple prompts, instructing a user to input information, perform acts, and the like. For example, the GUI 109 may prompt the user to input event information through the GUI 109. An input menu may be provided via the GUI 109 to allow a user to input the event information associated with a body part of the user. In another example, the GUI 109 may prompt or notify the user of reminders, and provide messages pertaining to event information input by the user.

In another example, the GUI 109 may be a communication interface to allow users to message each other through a communication session. The communication session can be a communication interaction between users such as a telephone call between two users or between three or more users. The communication session can be mode-neutral so that users in the session can communicate using any of a number of communication modes such as telephone, cellular phone, voice over IP (VoIP), video conference, text message, instant messaging, web-based chat, e-mail, live in-person conversation, and so forth. The communication session can also be multi-media/modal and combine two or more of the modes listed above. The GUI 109 allows users to initiate and/or manipulate the communication session quickly and intuitively.

In another example, the GUI 109 may include icons for each user profile, badges, and the like. For example, a first user may allow its profile to be public so that a second user may view the first user's profile. The second user may click on the icon of the first user to engage with the first user's profile. Once in the first user's profile, the first user's avatar can be seen by the second user. Further, since the first user gave permission for the second user to view its profile, the first user's profile may display information the first user decided to make public. Such information may include: birth date, age, location, personalized avatar, reminders, and the like.

The system 102 also includes a database 107. The electronic documents of the database 107, received, transmitted, and/or stored by the system 102, may be a plurality of electronic documents and may include, for example, information relating to users and other users of the system 102, such as usernames, passwords, personalized avatars, and the like.

The event information of the database 107, received, transmitted, and/or stored by the system 102, may be a plurality of event information and may include, for example, information relating to a user's event, goal, service, appointment, task, reminder, or the like.

In one embodiment, the documents of the database 107 may be structured with a pre-defined data model or format. In another embodiment, the documents of the database 107 may be unstructured. In yet another embodiment, the database 107 may contain both structured and unstructured documents. Structured data is data in a defined format, or code, that makes it easily readable and/or searchable by a computer. Examples of structured data include JavaScript Object Notation (JSON), Extensible Markup Language (XML) formatted files, YAML Ain′t Markup Language (YAML) and fixed width/field file formats. Unstructured data is not structured with pre-defined data models or schema. Examples of unstructured data may include the content of documents, journals, books, health records, metadata, audio, video, analog data, images, files, and unstructured text such as the body of an e-mail message, Web page, or word-processor document. Besides the difference between how structured or unstructured data is stored in a relational database versus stored outside of one, the biggest difference is the ease of analyzing structured data versus unstructured data. Mature analytics tools exist for structured data, but analytics tools for mining unstructured data may be emerging and developing. Dealing with unstructured data is important, since a vast majority (i.e., 80% or higher) of all potentially usable business information may originate in unstructured form.

It will be appreciated that the database 107 may be stored in a memory 105 or other non-transitory medium coupled with the system 102 and may be implemented by a plurality of databases, each of which stores a portion of the information. The database 107 is structured with a pre-defined data model or format, such as a relational database having a relational model of data. The database 107 includes a plurality of data items, or entities, stored in association with one or more properties. Each property is associated with a value. The relation from an item to a property is a one too many, with each of the latter having an associated value. In a Relational Database Management System (RDBMS), which is a software system used to maintain relational databases, an item is a row and a property is a related value of the item in a column. Stated another way, a property is an entity's data value, or the data instances themselves. A name space may be incorporated into the name of a property since there is no hierarchy to them. For example, the property “user.age” could represent a column “age” in a “user” table found in an RDBMS.

The network environment 100 shown in FIG. 1 includes computer devices 124, 126, 128, 130, and 132, which depict different methods or media by which a computer device may be coupled with the system 102 or by which a user may process or communicate, e.g., send and receive, electronic documents or other information therewith. It will be appreciated that the types of computer devices deployed by users and the methods and media by which they communicate with the system 102 is implementation dependent and may vary and that not all of the depicted computer devices and/or means/media of communication may be used and that other computer devices and/or means/media of communications, now available or later developed may be used. Each computer device, which may comprise a computer 200 described in more detail below with respect to FIG. 2, may include a central processor that controls the overall operation of the computer and a system bus that connects the central processor to one or more conventional components, such as a network card or modem. Each computer device may also include a variety of interface units and drives for reading and writing data or files and communicating with other computer devices and with the system 102. Depending on the type of computer device, a user can interact with the computer with a keyboard, pointing device, microphone, pen device, touch screen, GUI, or other input device now available or later developed.

An exemplary computer device 124 is shown directly connected to the system 102 in FIG. 1, such as via a T1 line, a common local area network (LAN) or other wired and/or wireless medium for connecting computer devices, such as the network 220 shown in FIG. 2 and described below with respect thereto. The exemplary computer device 124 is further shown connected to a radio 140. The user of radio 140, which may include a cellular telephone, smartphone, or other wireless proprietary and/or non-proprietary device, may be a user of the application. The radio user may transmit electronic documents or other information to the exemplary computer device 124 or a user thereof. The user of the exemplary computer device 124, or the exemplary computer device 124 alone and/or autonomously, may then transmit the electronic documents or other information to the system 102.

As shown in FIG. 1, exemplary computer devices 126 and 128 are coupled with a LAN 134 which may be configured in one or more of the well-known LAN topologies, e.g., star, daisy chain, etc., and may use a variety of different protocols, such as Ethernet, TCP/IP, etc. The exemplary computer devices 126 and 128 may communicate with each other and with other computers and other devices that are coupled with the LAN 134. Computers and other devices may be coupled with the LAN 134 via twisted pair wires, coaxial cable, fiber optics, or other wired or wireless media. As shown in FIG. 1, an exemplary wireless personal digital assistant device (“PDA”) 132, such as a mobile telephone, tablet-based compute device, or other wireless device, may communicate with the LAN 134 and/or the Internet 136 via radio waves, such as via Wi-Fi, Bluetooth and/or a cellular telephone based data communications protocol. PDA 132 may also communicate with the system 102 via a conventional wireless hub 138.

FIG. 1 also shows the LAN 134 coupled with a WAN 136, which may be comprised of one or more public or private wired or wireless networks. In one embodiment, the WAN 136 includes the Internet 136. The LAN 134 may include a router to connect LAN 134 to the Internet 136. Exemplary computer device 130 is shown coupled directly to the Internet 136, such as via a modem, DSL line, satellite dish, or any other device for connecting a computer device to the Internet 136 via a service provider, therefore as is known. LAN 134 and/or WAN 136 may be the same as the network 220 shown in FIG. 2 and described below with respect thereto. One of ordinary skill in the art will appreciate that numerous additional computers and systems may be coupled to the system 102.

The operations of computer devices and systems shown in FIG. 1 may be controlled by computer-executable instructions stored on a non-transitory computer-readable medium. For example, the exemplary computer device 126 may include computer-executable instructions for receiving electronic documents from a user and transmitting that information to the system 102. In another example, the exemplary computer device 128 may include computer-executable instructions for providing electronic messages to the system 102 and/or receiving electronic documents or other messages from the system 102 and displaying that information to a user.

Of course, numerous additional servers, computers, handheld devices, personal digital assistants, telephones, and other devices may also be connected to the system 102. Moreover, one having ordinary skill in the art will appreciate that the topology shown in FIG. 1 is merely an example and that the components shown in FIG. 1 may include other components not shown and be connected by numerous alternative topologies.

Referring to FIG. 2, an illustrative embodiment of a general computer system 200 is shown. The computer system 200 can include a set of instructions 212 that can be executed to cause the computer system 200 to perform any one or more of the methods or computer based functions disclosed herein. The computer system 200 may operate as a standalone device or may be connected, e.g., using a network, to other computer systems or peripheral devices. Any of the components discussed above, such as the processor 103, may be a computer system 200 or a component in the computer system 200.

In a networked deployment, the computer system 200 may operate in the capacity of a server or as a client user computer in a client-server user network environment, or as a peer computer system in a peer-to-peer (or distributed) network environment. The computer system 200 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 200 can be implemented using electronic devices that provide voice, video or data communication. Further, while a single computer system 200 is illustrated, the term “system” shall also be taken to include any collection of systems or sub-systems that individually or jointly execute a set, or multiple sets, of instructions to perform one or more computer functions.

As illustrated in FIG. 2, the computer system 200 may include a processor 202, e.g., a central processing unit (CPU), a graphics processing unit (GPU), or both. The processor 202 may be a component in a variety of systems. For example, the processor 202 may be part of a standard personal computer or a workstation. The processor 202 may be one or more general processors, digital signal processors, specifically configured processors, application specific integrated circuits, field programmable gate arrays, servers, networks, digital circuits, analog circuits, combinations thereof, or other now known or later developed devices for analyzing and processing data. The processor 202 may implement a software program, such as code generated manually (i.e., programmed).

The computer system 200 may include a memory 204 that can communicate via a bus 208. The memory 204 may be a main memory, a static memory, or a dynamic memory. The memory 204 may include, but is not limited to, computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 204 includes a cache or random-access memory for the processor 202. In alternative embodiments, the memory 204 is separate from the processor 202, such as a cache memory of a processor, the system memory, or other memory. The memory 204 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 204 is operable to store instructions 212 executable by the processor 202. The functions, acts or tasks illustrated in the figures or described herein may be performed by the programmed processor 202 executing the instructions 212 stored therein or stored in the memory 204. The functions, acts or tasks are independent of the particular type of instructions set, storage media, processor or processing strategy and may be performed by software, hardware, integrated circuits, firmware, micro-code, and the like, operating alone or in combination. Likewise, processing strategies may include multiprocessing, multitasking, parallel processing, and the like.

As shown, the computer system 200 may further include a display unit 214, such as a liquid crystal display (LCD), an organic light emitting diode (OLED), a flat panel display, a solid-state display, a cathode ray tube (CRT), a projector, a printer or other now known or later developed display device for outputting determined information. The display 214 may act as an interface for the user to see the functioning of the processor 202, or specifically as an interface with the software stored in the memory 204 or in the drive unit 206.

Furthermore, the computer system 200 may include a graphical user interface (GUI), such as GUI 109 described above, configured to allow users to interact with electronic devices through graphical icons and audio indicators. The GUI 109 may act as an interface for the user to see the functioning of the processor 202, or specifically as an interface with the software stored in the memory 204 or in the drive unit 206.

Additionally, the computer system 200 may include an input device 216 configured to allow a user to interact with any of the components of system 200. The input device 216 may be a number pad, a keyboard, or a cursor control device, such as a mouse, or a joystick, touch screen display, remote control, or any other device operative to interact with the system 200. The input device 216 may be a part of the GUI 109 or may be a separate component.

In a particular embodiment, as depicted in FIG. 2, the computer system 200 may also include a disk or optical drive unit 206. The disk drive unit 206 may include a computer-readable medium 210 in which one or more sets of instructions 212, e.g., software, can be embedded. Further, the instructions 212 may embody one or more of the methods or logic as described herein. In a particular embodiment, the instructions 212 may reside completely, or at least partially, within the memory 204 and/or within the processor 202 during execution by the computer system 200. The memory 204 and the processor 202 also may include computer-readable media as discussed above.

The present disclosure contemplates a computer-readable medium that includes instructions 212 or receives and executes instructions 212 responsive to a propagated signal, so that a device connected to a network 220 can communicate voice, video, audio, images or any other data over the network 220. Further, the instructions 212 may be transmitted or received over the network 220 via a communication interface 218. The communication interface 218 may be a part of the processor 202 or may be a separate component. The communication interface 218 may be created in software or may be a physical connection in hardware. The communication interface 218 is configured to connect with a network 220, external media, the display 214, or any other components in system 200, or combinations thereof. The connection with the network 220 may be a physical connection, such as a wired Ethernet connection or may be established wirelessly as discussed below. Likewise, the additional connections with other components of the system 200 may be physical connections or may be established wirelessly.

The network 220 may include wired networks, wireless networks, or combinations thereof. The wireless network may be a cellular telephone network, an 802.11, 802.16, 802.20, or WiMax network. Further, the network 220 may be a public network, such as the Internet, a private network, such as an intranet, or combinations thereof, and may utilize a variety of networking protocols now available or later developed including, but not limited to, TCP/IP based networking protocols.

Embodiments of the subject matter and the functional operations described in this specification may be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer-readable medium for execution by, or to control the operation of, data processing apparatus. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer-readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated or otherwise specifically configured hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

Although the present specification describes components and functions that may be implemented in particular embodiments with reference to particular standards and protocols, the present disclosure is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well. Feedback provided to the user can be any form of sensory feedback, e.g., visual feedback, auditory feedback, or tactile feedback. Input from the user can be received in any form, including acoustic, speech, or tactile input.

Embodiments of the subject matter described in this specification can be implemented in a computing system that includes a back end component, e.g., a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a LAN and a WAN, e.g., the Internet, as described above.

The computing system can include clients and servers. A client and server are generally remote from each other and typically interact through a communication network. The relationship of client and server arises by virtue of computer programs running on the respective computers and having a client-server relationship to each other. A system may depend on certain rules, logic, and inter-related objects and data. In technical and computing environments, a system may calculate values for multiple objects subject to rules, e.g., business or environment logic, associated with the objects. Certain object types may also depend on other object types.

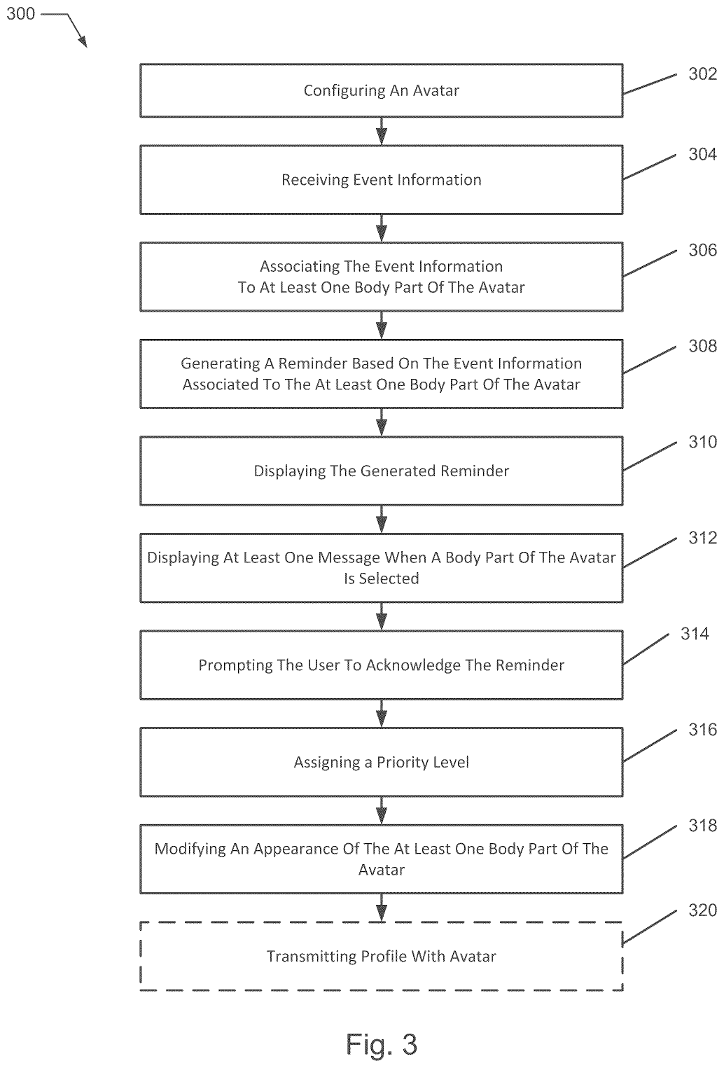

Described below with reference to FIGS. 3-11 is an example of an operation of an application of one embodiment of the present disclosure for a mobile device or computer. The operation may be performed by the processor 103 of the system 102 described above.

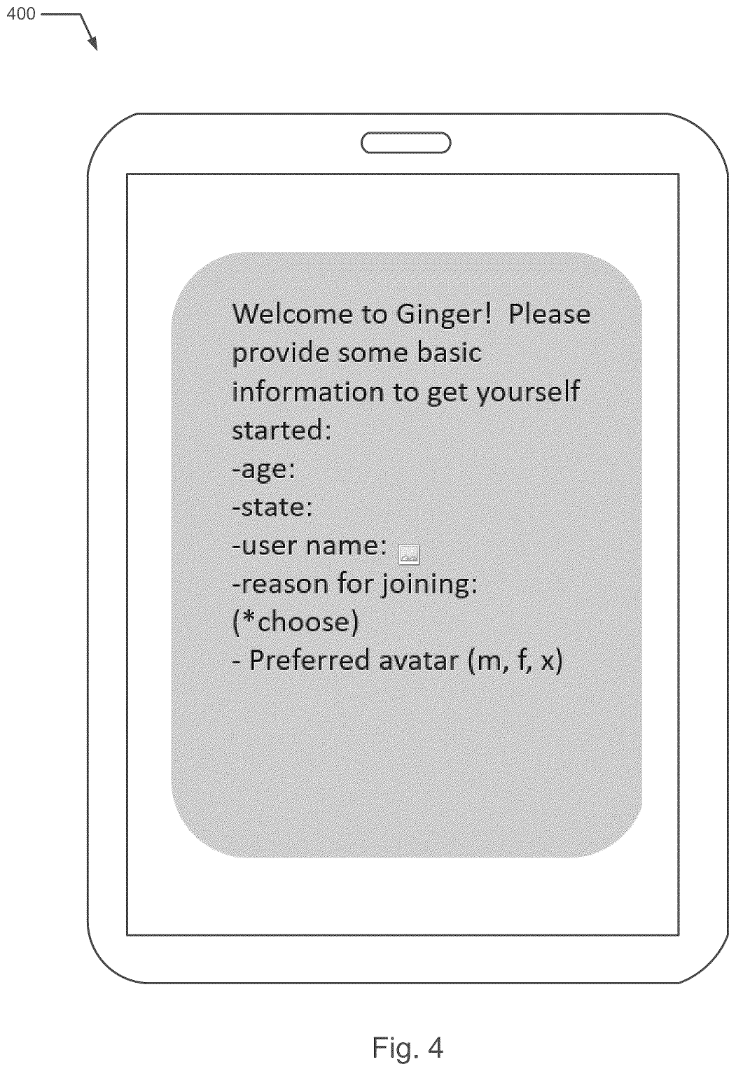

For example, when a user opens the disclosed application for the first time, the user is prompted to create a user profile. FIG. 4 illustrates a screenshot of a profile screen 400 from a mobile device in accordance with an embodiment of the disclosed system. The profile screen 400 includes information that may be made public or private. As illustrated in FIG. 4, the user may need to provide some basic information about him/her/themself. Such information may be age, gender, what state the user is located in (e.g., user location), a username, reasons for joining the application, other personal identification information and the like. Once a user has created a profile, the operation of the system 102 is run as illustrated in the flowchart in FIG. 3 and as described further below.

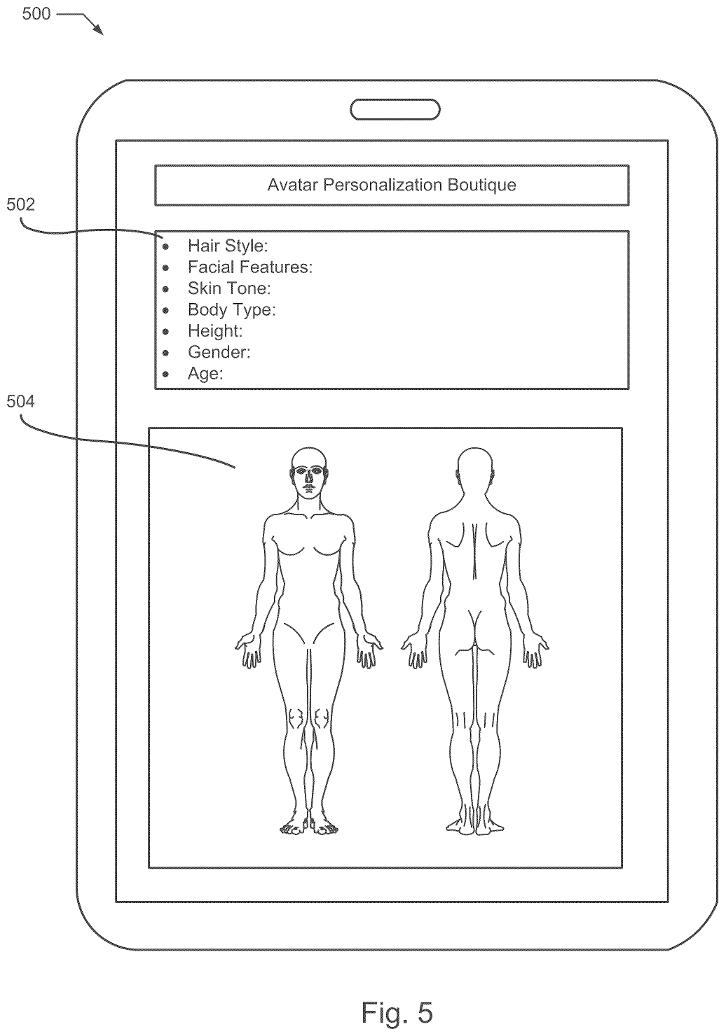

FIG. 3 illustrates a proposed flowchart 300 showing operation of the system 102 of FIG. 1. In particular, FIG. 3 shows a computer-implemented method for managing events using an avatar-based user interface. The operation includes configuring an avatar 504 to the user's preferred appearance (Block 302). For example, FIG. 5 illustrates a screenshot of an avatar configuration screen 500 from a mobile device in accordance with an embodiment of the disclosed system. The avatar configuration screen (e.g., Avatar Personalization Boutique) 500 includes a nonbinary avatar 504 and configuration preferences 502, where the user may choose how the avatar 504 looks.

For example, the user may choose configuration preferences and/or avatar templates to customize the shape, body figure, body features, and facial characteristics of the avatar.

The nonbinary avatar 504 is depicted as a blank canvas for the user to customize or personalize as they please. The avatar 504 is depicted as a two-dimensional avatar, however, the avatar is not limited to two dimensions and may instead be a three-dimensional avatar. Furthermore, as depicted in FIG. 5, the avatar 504 is modeled after a human being, however the avatar is not limited to humans, but can also be animals, robots, or the like.

In this configuration, the avatar is a nonbinary human configured to include body parts and sub-body parts. Therefore, the head of the avatar includes sub-body parts such as eyes, nose, mouth, ears, and the like, which users can select.

Furthermore, the avatar may include sub-body parts that represent the internal body parts of the avatar. The sub-body parts may further encompass the vital organs of the avatar. For example, when the user selects a body part of the avatar, such as the head, the user may also be able to select a sub-body part, such as the brain of the avatar located in the head of the avatar.

The screenshot of the avatar configuration screen 500 also includes a set of avatar characteristics. In this example, the set of avatar characteristics includes seven avatar characteristics from which the user may configure and/or personalize the avatar. The seven avatar characteristics depicted in FIG. 5 are: hair style, facial features, skin tone, body type, height, gender, and age. However, it should be noted that the set of avatar characteristics is not limited to seven characteristics, and any number of characteristics may be included.

As a user configures the avatar 504 to their preferred appearance, the avatar 504 is dynamically and continuously updated in real-time to reflect the altered features. For example, as the user selects the “facial features” characteristic, the user may adjust the eyes, eyebrows, nose, and mouth of the avatar to match its chosen desired features. In other words, the avatar 504 may be configured to look like whatever the user imagines or desires. As the “facial features” characteristic is changed, the avatar is updated (i.e., transformed) to reflect the chosen characteristic and displayed in real-time via the GUI 109.

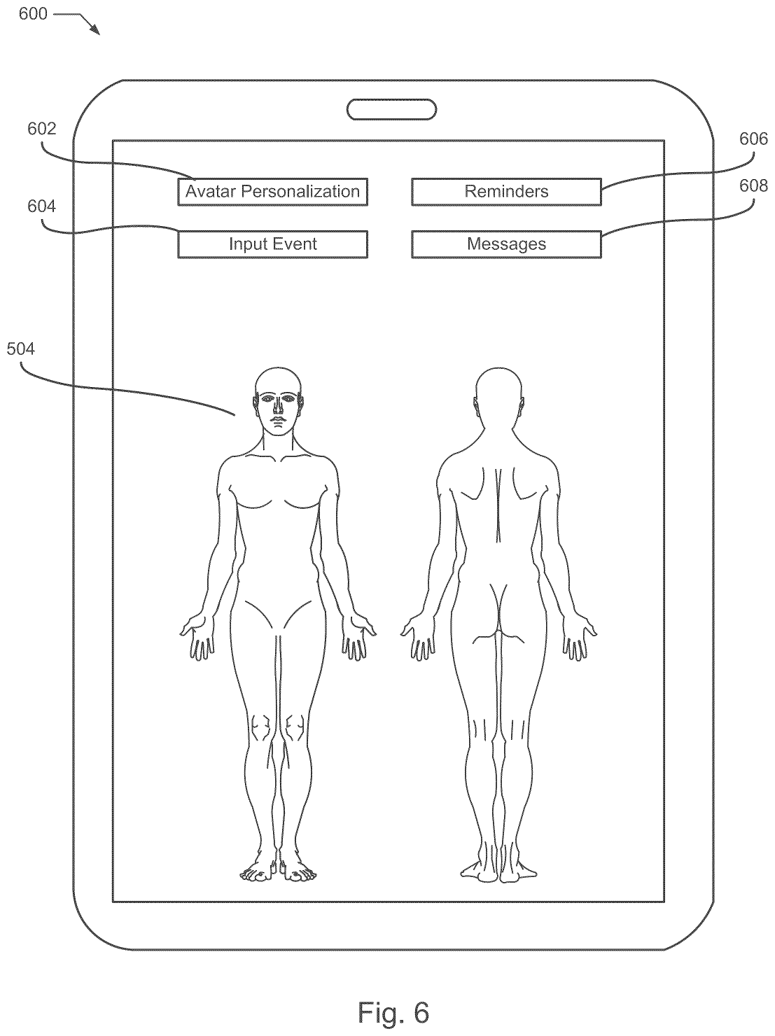

Referring back to FIG. 3, the operation further includes receiving, via the GUI 109, event information pertaining to a body part of the user (Block 304), as illustrated in FIGS. 6, 7, and 8.

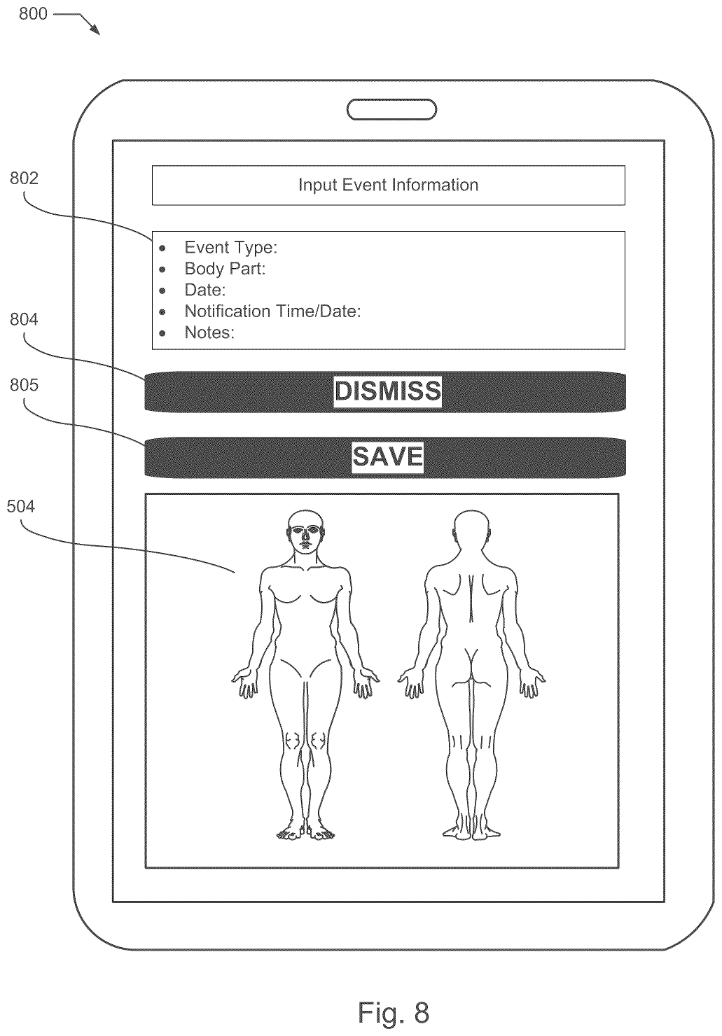

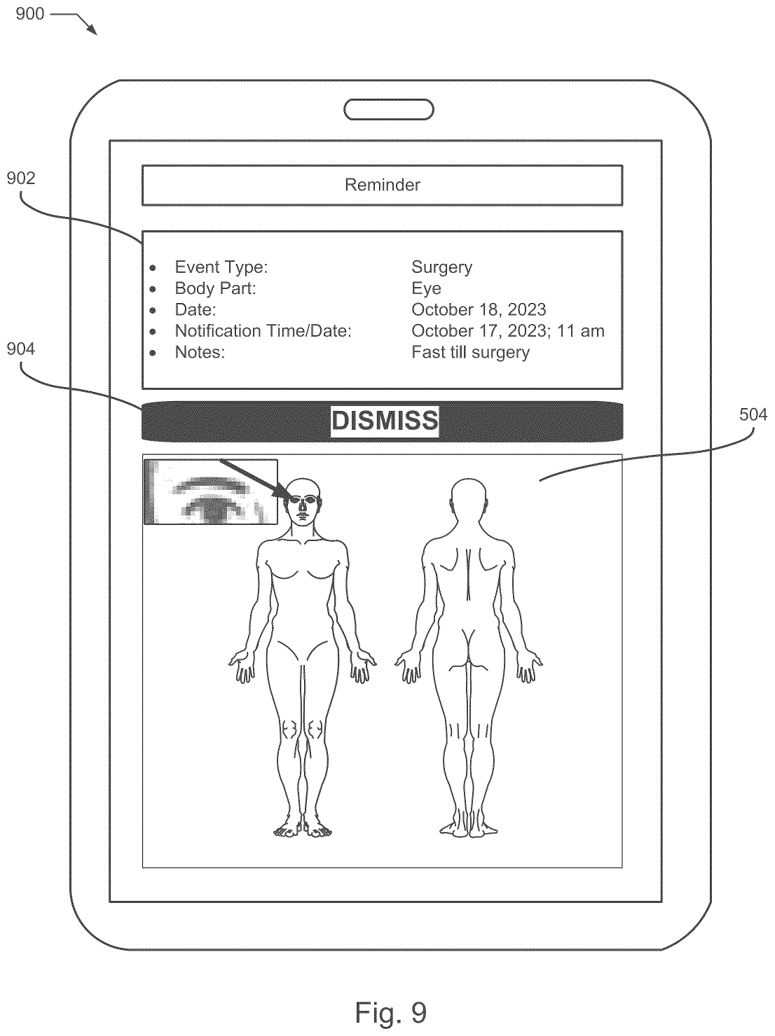

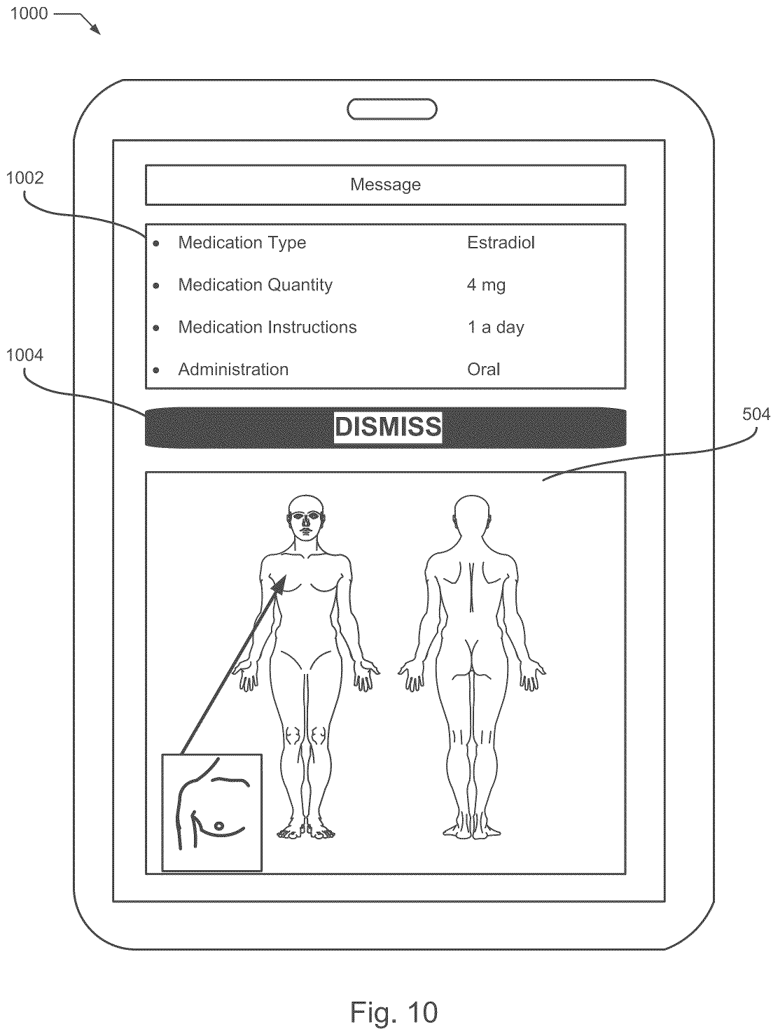

FIG. 6 illustrates a screenshot of a main menu 600 from a mobile device in accordance with an embodiment of the disclosed system. The main menu includes the avatar 504, an avatar personalization icon 602, an input event icon 604, a reminders icon 606, and a messages icon 608. The avatar 504 depicted in FIG. 6 is the personalized avatar described above, which may be configured upon selection of a body part (i.e., a user may select any body part of the avatar to configure/personalize it). The avatar personalization icon 602 is selectable such that a user may select the personalization icon 602 and be transferred to the avatar personalization boutique as described above and depicted in FIG. 5. The input event icon 604 is also selectable such that a user may select the input event icon 604 and be transferred to an input screen 800, described below with reference to FIG. 8. The reminders icon 606 is also selectable such that a user may select the reminders icon 606 and be transferred to a reminder screen 900, described below with reference to FIG. 9. Additionally, the messages icon 608 is selectable such that a user may select the messages icon 608 and be transferred to a message screen 1000, described below with reference to FIG. 10.

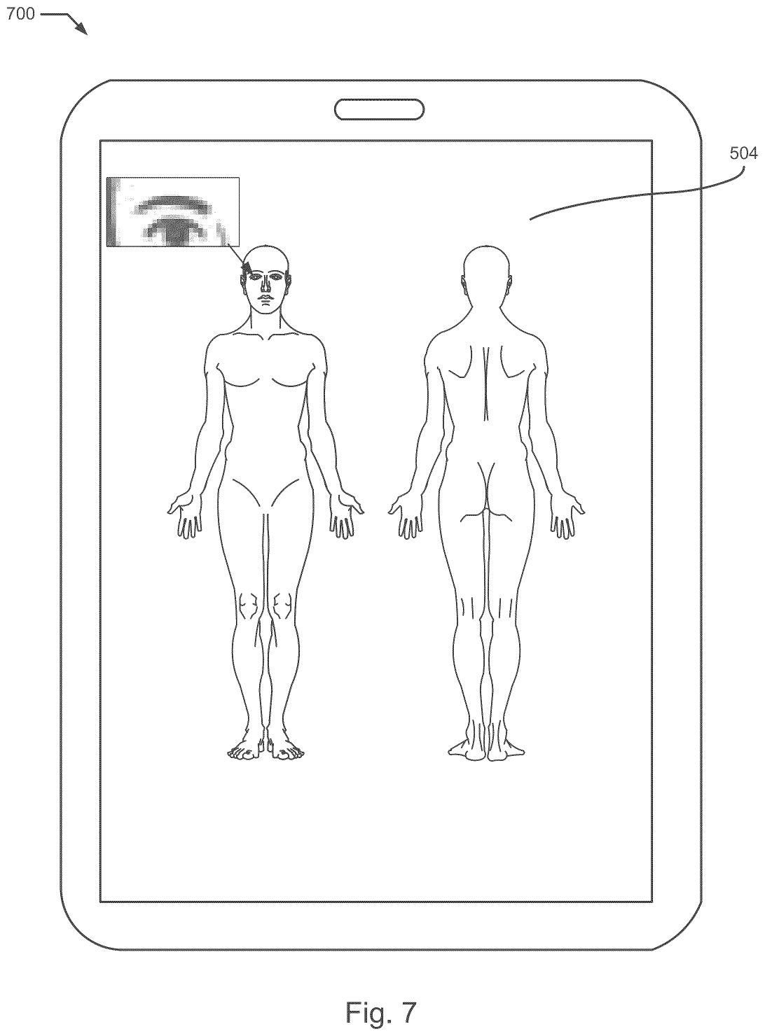

FIG. 7. depicts a screenshot 700 of the avatar 504 where a popup or insert image of a selected body part is displayed from a mobile device in accordance with an embodiment of the disclosed system. In other words, as a user hovers over or selects a body part of the avatar 504, a detailed image of the body part is popped up or highlighted to notify the user that the body part was selected. In this way, a user is notified that they have chosen or interacted with that particular body part of the avatar 504. FIG. 7 illustrates a body part being selected. In one example, the eye of the avatar 504 on the left side of the screenshot is depicted when selected. In another example, the eye of the avatar 504 is depicted when a cursor is hovered over the body part. This feature provides a distinct advantage by offering intuitive visual cues that empower users to easily grasp and engage with the avatar.

Furthermore, when a detailed image of the body part is popped up or highlighted when a user hovers over or selects that body part of the avatar 504, that body part of the avatar is considered “live.” A body part is considered “live” if that body part has at least one event associated with it.

In certain examples, a body part may be considered live when a window corresponding to the selected body part is open for adding/editing information. From this live setting, the user can then either save any updates (e.g., via a “SAVE” icon 805) or exit out (e.g., via a “DISMISS” icon 804) from the screen and hence from the “live” setting.

To deselect a selected or highlighted body part, the user may select or tap on the background of the screen, or select the “DISMISS” icon 804. This allows the user to close the popped up or highlighted body part.

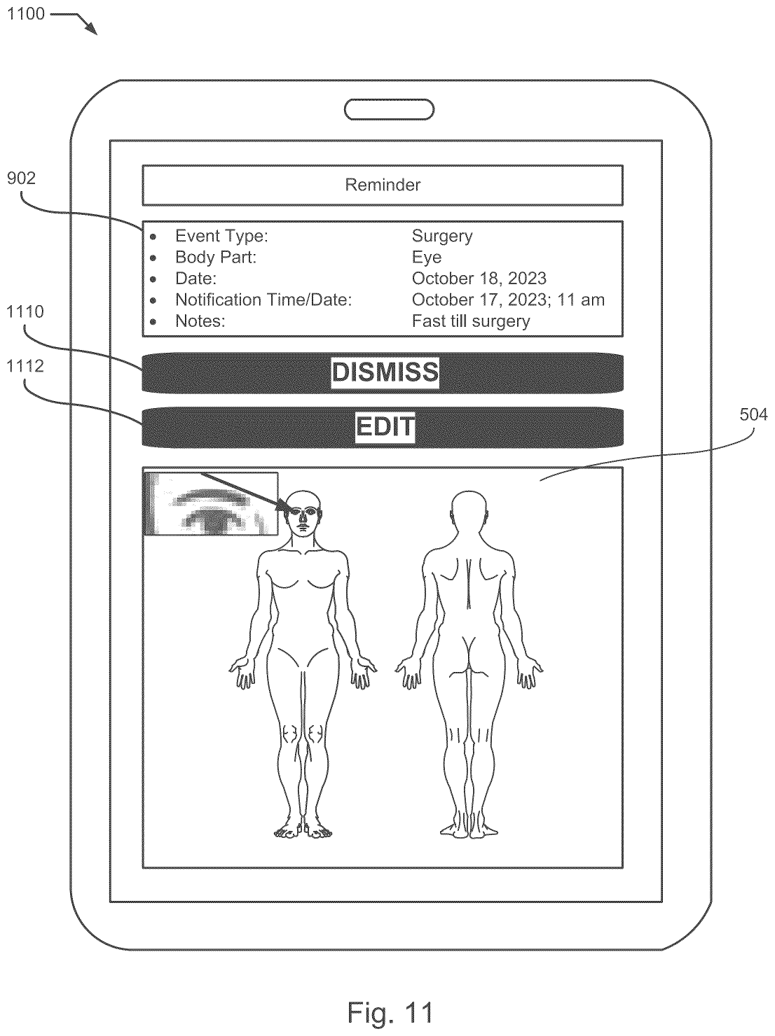

FIG. 8 illustrates a screenshot of an input screen 800 that allows a user to enter or edit event information from a mobile device in accordance with an embodiment of the disclosed system. The input screen 800 includes an input section 802 having an event type input portion, a body part input portion, a date input portion, a notification time/date input portion, a note input portion, and the like. The user may select the different input portions and then input the relevant event information. It should be noted that different input portions may be added and any number of input portions may be included in the input section 802 and that the input section 802 is not limited to the input portions disclosed herein. The user may also edit the relevant information via an “Edit” button, as described below with reference to FIG. 11. The user may actuate (e.g., click or tap) the “Edit” button 1112 via the GUI 109 to edit, update, and cancel existing events.

Furthermore, the input screen 800 includes a “DISMISS” icon 804. The icon 804 depicts a “DISMISS” button. The user may actuate (e.g., click or tap) the “DISMISS” button 804 via the GUI 109 to close out of the input screen.

For example, receiving the event information via the GUI 109 may occur when the user hovers or selects a body part of the avatar 504 to input the corresponding event information. As the user selects a body part, the selected body part is highlighted to notify the user that the body part was selected, as depicted in FIG. 7. Once the body part is selected, the screen on the GUI 109 changes and the user may input or edit the corresponding event information, as depicted in FIG. 8. Once, finished, the user may click on a “SAVE” icon 805 in order to save any newly added or edited information or the “DISMISS” icon 804 to close out of the input screen, without saving any changes made while the body part was “live”.

In another example, a user may select the head of the avatar to input event information associated with the head of the user. Alternatively, the user may select the head of the avatar and then further select the eyes of the avatar to input event information associated with the eyes of the user. Furthermore, the user may select the head of the avatar and then further select the brain of the avatar to input event information associated with the brain of the user.

In another embodiment, the information may be directly input via the input screen 800, which may be accessed by the main menu 600. For instance, a user may input all of the relevant information by accessing the input screen 800 from the main menu 600 without having to first select a body part of the avatar 504, as described above with reference to FIG. 7.

The information may be directly associated with a body part based on a predetermined relational database stored in the database 107 (described further below). In one example, the user may input information pertaining to a manicure, and the system may automatically associate the manicure with the avatar's hands based on a predetermined association between a hand of the avatar and an event entitled “manicure” stored in the database 107.

The event information (e.g., event data) may be indicative of appointment times with respect to a service provider, a task, a goal, and the like.

For instance, users can input various types of event information. This could include service providers, which may range from routine cosmetic services like hair treatment, nail treatment, and facial treatment, to essential medical services including surgeries, doctor visits, physical therapy, and hormone therapy. Additionally, users can also record details about body-centric services like massage therapy and body scrubs, as well as wellness-oriented services, which may encompass yoga classes, gym attendances, spa appointments, and similar offerings.

Furthermore, users have the option to input event information that is relevant to tasks associated with specific body parts. For instance, a user might have to take medication related to their heart health and wish to set a reminder for the medication schedule.

Additionally, users might enter event information connected to their fitness goals and body transformation desires. For example, a user could specify a desire to focus on leg workouts, setting a specific goal for the transformation of their legs. Alternatively, a user might set a specific goal pertaining to their health and well-being such as a diet.

By allowing users to input a wide array of event information, the system 102 advantageously ensures that individuals can effectively manage and schedule appointments, tasks, and engagements related to their personal care, health, and overall well-being through an avatar based interface, as opposed to a generic calendar based application. Whether it is planning a relaxing spa day, tracking essential medical appointments, or scheduling routine beauty treatments, the system 102 provides a comprehensive solution for users to stay organized and in control of their diverse event requirements as it pertains to their body.

Referring back to FIG. 3, the operation further includes associating the event information to at least one body part of the avatar (Block 306). The at least one body part of the avatar corresponds to the body part of the user. In other words, the event information pertains to a body part of the user, and once the user inputs the event information, the event information is associated to a body part of the avatar. Therefore, when a user selects a body part of the avatar, such as an eye, the event information pertaining to the user's eye is associated to the eye of the avatar.

Furthermore, more than one event information may pertain to a body part. For instance, the hand/fingers may be tagged to an upcoming hand surgery, as well as a manicure.

The processor 103 establishes a connection between the event information and a specific body part of the avatar through a relational database stored in the database 107, as described above. For each distinct region of the avatar 504, at least one table may be generated and stored in the database 107 having body part terms, which delineates the various body parts of the avatar. A linkage is defined between each term representing a body part in the table and its respective counterpart on the avatar. Consequently, when a user inputs event information through the input section 802, as illustrated in FIG. 8, the processor 103 correlates the provided body part name with the corresponding body part of the avatar 504 using the relational database.

In another example, the user may select a body part of the avatar 504 to which event information is desired to be associated with instead of inputting the body part in the input section 802. The processor 103 associates that event information by again using a relational database as described above.

The operation also includes generating a reminder for the user based on the event information associated to the at least one body part of the avatar (Block 308). This reminder is configured to trigger the user's memory regarding a specific time or situation related to the provided event information. For instance, if a user inputs information concerning an upcoming eye surgery of the user and that information is then associated with the avatar's eye, the system 102 generates a corresponding reminder that is associated with the avatar's eye. This reminder is then securely stored within the database 107, ensuring that crucial event details are not forgotten and can be readily accessed when needed. Each reminder is also assigned a priority level (discussed further below).

Once the reminder is generated (Block 308), the reminder may be displayed via the GUI 109 when the avatar's body part is selected (Block 310). For instance, using the example above regarding an upcoming eye surgery, when the avatar's eye is selected, the reminder is displayed. The reminder may also be displayed via the GUI 109 automatically on the date and time set by the user in the notification time/date portion of the input section 802 of the input screen 800. For example, on the date and time specified by the user, the reminder will automatically be displayed via the GUI 109 (e.g., push notification) to notify the user of the upcoming event. This reminder effectively conveys crucial event details, including the date, time, location, and any relevant instructions associated with the input event information.

FIG. 9 illustrates a screenshot 900 of a reminder of a mobile device in accordance with an embodiment of the disclosed system. Depicted in FIG. 9 is an example of a reminder based on event information pertaining to the eye of the user and then associated with the eye of the avatar 504. The event information is about a medical service. More particularly, the event information, in this example, pertains to surgery happening to the user's eye. Furthermore, as depicted in FIG. 9, the reminder 902 illustrates the event type, the body part, the date, the notification time/date, and the note sections all filled out. The eye of the avatar 504 to which the event information is associated is highlighted to visually indicate to the user which body part the reminder is associated with. Additionally, the reminder screen 900 includes a “DISMISS” icon 904. The icon 904 depicts a “DISMISS” button. The user may actuate (e.g., click or tap) the “DISMISS” button 904 via the GUI 109 to close out of the reminder 902.

In another example, the operation for system 102 may further include displaying, via the GUI 109, at least one message when a body part of the avatar is selected by a user (Block 312). In other words, when a body part of the avatar is selected or hovered over, a message may be displayed via the GUI 109, because the body part is considered “live.” The message may include notes, instructions, goals, tasks, medication, and the like pertaining to an event associated with the body part of the avatar.

For example, when a user chooses a body part, either by hovering over the body part or selecting the body part, if the selected body part has at least one associated event (indicating that the body part is “live”), the system 102 may zoom in on that specific body part to allow the user to verify if it matches the user's intended focus for detailed information. During this zoom-in, the user may observe one or more indications of associated events. Subsequently, the user can interact with the zoom window to choose a subpart of the body part (e.g., first selecting the head and then further selecting an eye within the head) and/or further specify which event or appointment information should be displayed. Once selected, the reminder, message, or a combination of the reminder and message may be displayed associated to the selected body part(s).

FIG. 10 illustrates an example of a screen 1000 of a message of a mobile device in accordance with an embodiment of the disclosed system. Referring to FIG. 10, a user may select the breast of the avatar 504. A message 1002 may be displayed with the selected body part highlighted. Message 1002 provides the user with information pertaining to the event (e.g., hormone therapy) associated with the selected breast of the avatar 504. The message may, for example, include information explaining the event, such as “hormone therapy involves the use of hormones, typically estrogen and sometimes anti-androgens, to promote the development of breast tissue and other feminine secondary sexual characteristics” (not illustrated). The message may also include information about what medication the user needs for the hormone therapy, when to take such medication, the quantity of drugs, and the like, as illustrated in FIG. 10. The selected body part may be highlighted and displayed at the same time as the message to advantageously help the user associate the displayed message to that body part. Once the user has finished reading the message, the user may click on the “DISMISS” icon 1004 to close out of the message.

Additionally, the system 102 advantageously displays the message and selected body part simultaneously to help motivate the user. This dual presentation serves to further motivate the user, enhancing their engagement with the system 102. In other words, when a user receives a reminder, not only is the message clearly conveyed but also, in parallel, the relevant body part of the avatar is highlighted or represented. This visual connection between the reminder and the corresponding body part serves as a compelling visual cue, reinforcing the significance of the task or event associated with that particular body part. This approach contributes to a more immersive and effective user experience, strengthening the user's commitment to fulfilling their responsibilities and appointments. It also makes the user's particular avatar more familiar to the user's unique experience (vs. a generic set of prescribed appointments for any user). For example, consider a user undergoing hormone therapy during their gender transition. In moments of doubt or discouragement, visualizing their preferred body or the appearance they aspire to achieve through the avatar can offer profound motivation and encouragement to persevere with the transitioning process.

The operation for system 102 may further include prompting the user to acknowledge the reminder (Block 314). Acknowledging the reminder means that the user takes some action to confirm that they have seen or recognized the reminder and are aware of the information or task it conveys. For example, the system 102 may remind the user of an event pertaining to a user's hormone therapy. The notification may be displayed via the GUI 109 and include the therapy's date, time, location, and any relevant information such as instructions or medication. In this case, for example, the user may be notified every day or week to take the necessary medication for hormone therapy. The user may then acknowledge the reminder by actuating an icon on the GUI 109 to dismiss the reminder, as depicted in FIG. 11.

FIG. 11 illustrates a screenshot 1100, which includes a “DISMISS” icon and the reminder, of a mobile device in accordance with an embodiment of the disclosed system. The icon 1110 depicts a “DISMISS” button. The user may actuate (e.g., click or tap) the “DISMISS” button 1110 via the GUI 109.

FIG. 11 also illustrates a screenshot 1100, which includes an “Edit” icon. The icon 1112 depicts an “Edit” button. The user may actuate (e.g., click or tap) the “Edit” button 1112 via the GUI 109 to edit, update, and cancel existing events.

Acknowledging reminders offers several valuable advantages. By acknowledging a reminder, individuals can enhance their task management skills, ensuring that important events and responsibilities are not overlooked. Moreover, acknowledging reminders fosters a sense of accountability, motivating individuals to fulfill their commitments promptly. This interaction also drives user engagement with the application, leading to more personalized and efficient interactions. Ultimately, the practice of acknowledging reminders contributes to better organization, streamlined communication, and improved overall efficiency in daily activities.

Furthermore, the operation for system 102 may include assigning a priority level to the generated reminder based on a deadline of the reminder or a level of importance (Block 316). In other words, multiple reminders may be generated where each reminder is associated with a different and/or the same body part of the avatar. Each reminder may have a different deadline or level of importance.

One example of a criterium for determining the priority level of a reminder is its deadline. In other words, how soon a particular reminder needs to be acted upon or completed is a crucial factor. Reminders with closer deadlines are assigned higher priority levels, signifying that they require immediate attention or action. For example, the processor 103 determines a priority level based on the time before a deadline is reached. The closer a deadline approaches for an event, the higher the priority level is assigned to the event. A priority level may range from 0 to 5 with 5 being the highest or most urgent priority level.

The level of importance of a reminder is another example of a criterium of consideration for priority assignment. Not all reminders are of equal significance. Some tasks or events may be more critical than others. For example, a reminder for hormone therapy might be deemed more important than a reminder for a haircut appointment. The level of importance for each body part or event type is input by the user in the input section 802. The user may assign the level of importance in a range between 0 to 5 with 5 being the highest or most important. The above described criteria for determining a priority level of a reminder are examples and any number of other criteria may be used to determine a priority level.

To determine an overall priority level for a body part or event type associated with a body part, the processor 103 determines the average between the priority level assigned to a deadline and the priority level assigned to a level of importance. The overall priority level is then assigned to the corresponding body part and/or input event type. In another example, a separate priority level is assigned for each. In other words, a reminder for an event corresponding to a body part may be assigned one priority level based on corresponding deadlines alone and another priority level based on level of importance alone. In one example, the user may be able to select which priority level takes precedence. In another example, both priority levels remain associated with the reminder corresponding to the body part.

Thus, each reminder is assigned a priority level (or one or more priority levels) based on the deadline and/or level of importance. By assigning priority levels to these reminders, the system 102 can advantageously help users focus their attention on the most time-sensitive and critical matters.

The operation for system 102 may further include modifying the appearance of the at least one body part of the avatar associated with the reminder based on the assigned priority level (Block 318). In other words, the system 102 may provide visual cues for body parts of the avatar associated with a priority level for their reminders. Therefore, the system 102 has the capability to visually distinguish body parts of the avatar associated with different priority levels for their respective reminders. In this regard, the system 102 may create a “heat map,” which is a representation of data in the form of a map or diagram in which data values (priority levels in this example) are represented as colors, shades of black/grey/white, or other varying patterns and the like to distinguish values from one another.

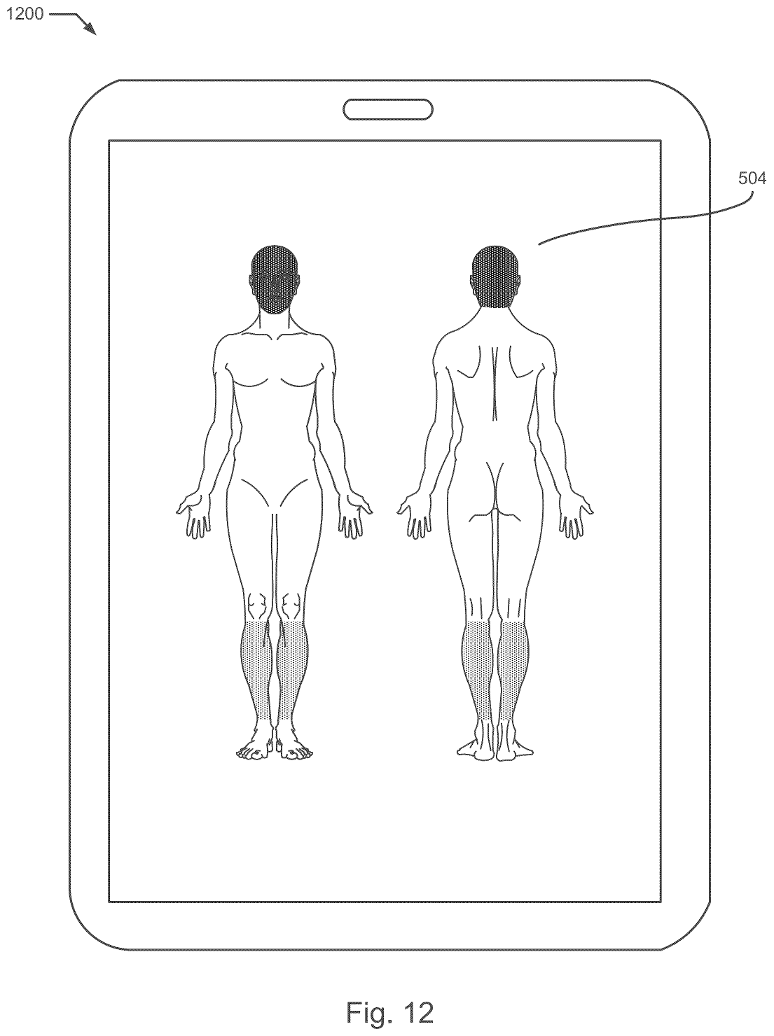

FIG. 12 illustrates a screenshot 1200, which includes the avatar having body parts assigned to different priority levels, of a mobile device in accordance with an embodiment of the disclosed system. Referring to FIG. 12, the avatar 504 is depicted as having both its head and legs assigned a priority level. In this example, different colors or shadings are used to differentiate the different priority levels. Other indicators may be used, such as numerical call outs for each body part assigned a priority level, outlining the body parts, and the like. In other words, FIG. 12 illustrates a heat map where at least one body part, assigned a priority level, is represented by a distinct color or shade, effectively conveying the level of importance to the user. In one example, a darker color or shade may be indicative of a higher priority level.

For example, the system 102 receives event information concerning the user's head and legs (or at least a portion of the legs). Subsequently, the system 102 associates the event information related to the user's head with the avatar's head and associates the event information concerning the user's legs with the avatar's legs. The event information concerning the user's head is deemed to hold significant importance due to the context of a nose surgery, while the event information concerning the user's legs holds lower importance, as it pertains to a waxing treatment. A first reminder based on the event information associated with the avatar's head is generated, and a second reminder based on the event information tied to the avatar's legs is generated. Consequently, the avatar's head is granted a high-priority status in accordance with the level of importance, while the avatar's legs are assigned a low-priority status. To visually convey this prioritization, alterations are made to the avatar's appearance, as illustrated in FIG. 12. Specifically, the avatar's head adopts a darker coloration to signal to the user that the reminder associated with the head carries a higher priority level than the reminder linked to the legs.

Another example may relate to multiple reminders being assigned priority levels based on their deadlines. For instance, when faced with multiple reminders scheduled for the same day, the system's processor 103 compares the overall priority levels of each reminder, ensuring a streamlined display for the user. For instance, if a nose surgery reminder is designated a priority level of 5, surpassing a manicure reminder with a level 4 priority, the system employs a visual differentiation by displaying the reminders in different colors. This intuitive approach enables users to readily discern the varying urgency or importance of tasks. Furthermore, in cases where multiple reminders share the same highest priority level, the system maintains clarity by presenting them with a consistent pattern or color associated with that priority level, facilitating quick recognition of tasks of equal significance.

This dynamic prioritization ensures that urgent or time-critical tasks receive the user's immediate attention, while tasks with more flexible timelines are acknowledged but do not disrupt the user's focus on immediate, pressing matters.

In another example, when multiple reminders are linked to the same body part, a numerical badge may be shown next to or associated with the body part. This badge indicates the number of reminders or scheduled events associated with that specific body part. For example, if a separate event/reminder is associated with the eyes, nose, and mouth of the avatar, a numerical badge in the form of a small bubble, for example, may be displayed next to the head of the avatar with a number “3” to indicate that three events/reminders pertain to the head of the avatar. As described above, a user may select the head and zoom-in on the head to then either further select subparts of the head, such as the eyes, nose, or mouth, to see the different events/reminders associated with those body parts.

In another embodiment, the system 102 may employ various visual cues and alerts to communicate these priority levels effectively. High-priority reminders may trigger more noticeable alerts, such as popup notifications, vibrant colors, or sound cues, to capture the user's attention promptly. In contrast, low-priority reminders may employ subtler visual indications, like muted colors or smaller notification icons, signaling their lower urgency without causing unnecessary distraction.

By adapting the avatar's appearance and employing these intelligent priority assignments, the system 102 enhances the user's experience by providing clear, context-aware cues that aid in managing and prioritizing tasks efficiently as it relates the avatar to the user's own body. This ensures that the user remains in control of their schedule and can address their commitments effectively, whether they involve significant events like medical appointments or less critical tasks like personal grooming appointments.

The operation may also include storing a user's personalized avatar under the user profile in the database 107. The user profile includes the personalized avatar having the generated reminders associated to at least one body part of the avatar. Storing the user's avatar under the user's profile preserves the avatar's appearance, associated reminders, and also ensures that the user's customization and preferences are readily accessible for future interactions.

Additionally, the operation may transmit or share the user's profile to another user (Block 320), such as to enable collaboration between each user. By allowing the user to share their personalized avatar with other users, the system 102 advantageously allows users to coordinate and share events. Furthermore, users going through similar events may be able to come together to help each other through obstacles by sharing their avatars as an outline or template for guidance and inspiration. For example, a user's avatar can serve as a source of inspiration, showing what is achievable and offering a clear path forward. Users can replicate successful approaches and adapt them to their own circumstances.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of ordinary skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the disclosure or of what may be claimed, but rather as descriptions of features specific to particular embodiments of the disclosure. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the described embodiments should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of ordinary skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, which are intended to define the spirit and scope of this invention.

1. A system for managing events using an avatar-based user interface, the system comprising:
a graphical user interface (GUI) for a user to visually interact with an avatar; and
at least one processor configured to:
receive, via the GUI, event information pertaining to a body part of the user;
associate the event information to a body part of the avatar, wherein the body part of the avatar corresponds to the body part of the user; and
generate a reminder for the user based on the event information associated to the body part of the avatar.

2. The system of claim 1, wherein the avatar is configured to be personalized, and wherein the avatar is a two-dimensional or three-dimensional figure.

3. The system of claim 1, wherein the body part of the avatar comprises subparts.

4. The system of claim 1, wherein the event information is indicative of appointment information with respect to a service provider, indicative of tasks, indicative of goals, or a combination thereof.

5. The system of claim 1, wherein the at least one processor is configured to:
display, via the GUI, the reminder, wherein the reminder includes a date, a time, and a location associated with the event information.

6. The system of claim 1, wherein the at least one processor is further configured to prompt, via the GUI, the user to acknowledge the reminder.

7. The system of claim 1, wherein the at least one processor is further configured to:
assign a priority level to the reminder based on a deadline of the reminder, a level of importance of the reminder, or a combination thereof; and
modify an appearance of the body part of the avatar associated with the reminder based on the priority level.

8. The system of claim 7, wherein, when a plurality of reminders is generated, the processor is further configured to assign respective priority levels to the plurality of reminders and generate a heat map of the plurality of reminders based on the respective priority levels.

9. The system of claim 1, wherein the at least one processor is further configured to:
display, via the GUI, at least one message when the body part of the avatar is selected,
wherein the message and the selected body part of the avatar are displayed simultaneously, and
wherein the message includes a date, a time, a location, a description, a priority level, or a combination thereof associated with the event information.

10. The system of claim 1, wherein the at least one processor is further configured to:
store a user profile associated with the user in a database, the user profile including the avatar having the generated reminder associated to the body part of the avatar; and
transmit the user profile to at least one other user, such as to enable collaborative interaction between the users.

11. A computer-implemented method for managing events using an avatar-based user interface, the computer-implemented method comprising:
receiving, by a processor through a graphical user interface (GUI), event information pertaining to a body part of the user;
associating, by the processor, the event information to a body part of an avatar, wherein the body part of the avatar corresponds to the body part of the user; and
generating, by the processor, a reminder for the user based on the event information associated to the body part of the avatar.

12. The computer-implemented method of claim 11, further comprising:
assigning, by the processor, a priority level to the generated reminder based on a deadline of the reminder, a level of importance of the reminder, or a combination thereof; and
modifying, by the processor, an appearance of the body part of the avatar associated with the reminder based on the priority level.

13. The computer-implemented method of claim 11, further comprising:
displaying, via the GUI, the reminder, wherein the reminder includes a date, a time, and a location associated with the event information.

14. The computer-implemented method of claim 11, further comprising:
prompting, by the processor, the user to acknowledge the reminder.

15. The computer-implemented method of claim 11, further comprising:
displaying, via the GUI, at least one message when the body part of the avatar is selected,
wherein the message and the selected body part of the avatar are displayed simultaneously, and
wherein the message includes a date, a time, a location, a description, a priority level, or a combination thereof associated with the event information.

16. The computer-implemented method of claim 11, wherein the avatar is configured to be visually interacted with via the GUI.

17. The computer-implemented method of claim 11, wherein the avatar is configured to be personalized, and wherein the avatar is a two-dimensional or three-dimensional figure.

18. The computer-implemented method of claim 11, wherein the body part of the avatar comprises subparts.

19. The computer-implemented method of claim 11, wherein the event information is indicative of appointment information with respect to a service provider, indicative of tasks, indicative of goals, or a combination thereof.

20. The computer-implemented method of claim 11, further comprising:
storing, by the processor, a user profile associated with the user in a database, the user profile including the avatar having the generated reminder associated to the body part of the avatar; and
transmitting, by the processor, the user profile to at least one other user, such as to enable collaborative interaction between the users.

21. A system for managing events using an avatar-based user interface, the system comprising:
a means for receiving event information pertaining to a body part of the user;
a means for associating the event information to a body part of the avatar, wherein the body part of the avatar corresponds to the body part of the user; and
a means for generating a reminder for the user based on the event information associated to the body part of the avatar.

22. The system of claim 21, further comprising:
a means for assigning a priority level to the reminder based on a deadline of the reminder, a level of importance of the reminder, or a combination thereof; and
a means for modifying an appearance of the body part of the avatar associated with the reminder based on the priority level.
